(19) United States
(12) Patent Application Publication
(10) Pub. No.: US 2019/0069718 A1
(43) Pub. Date: Mar. 7, 2019

(54) DISH HEATING SYSTEM AND METHOD OF USE

(71) Applicant: Jennifer Wohlschlegel, JR., Littleton, CO (US)

(72) Inventor: Jennifer Wohlschlegel, JR., Littleton, CO (US)

(21) Appl. No.: 16/122,498

(22) Filed: Sep. 5, 2018

Related U.S. Application Data
(60) Provisional application No. 62/554,162, filed on Sep. 5, 2017.

(51) Int. Cl. A47J 36/24; H05B 3/00

(52) U.S. Cl. CPC A47J 36/2483; F24C 7/062; H05B 3/0076

(57) ABSTRACT

A heated dish system includes a dish; and a heating apparatus to removably hold the dish, the heating apparatus having a base to receive the dish; a control system having an internal power source to charge via an external cable to plug into an electrical port; and one or more inserts to heat via receiving power from the internal power source; the one or more inserts are to be inserted into the dish to heat food within the dish.

### BACKGROUND

### 1. Field of the Invention

The present invention relates generally to food and beverage heating systems, and more specifically, to a dish heating system for conveniently heating food and beverages.

### 2. Description of Related Art

Heating systems are well known in the art and are effective means to cook and heat food. For example, FIG. 1 depicts a conventional heating system 101 having a stove 103 with one or more burners 105 and a pan 107. During use, the stove 103 and burners 105 provide power to heat pan 107 to cook or heat food.

One of the problems commonly associated with system 101 is portability. For example, stoves, as well as other heating systems, are not easily transported and used in remote locations.

Accordingly, although great strides have been made in the area of heating systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified oblique view of a common food heating system;

FIGS. 2A and 2B are front simplified front views of a heating dish system in accordance with a preferred embodiment of the present application;

FIG. 3 is a top view of a dish and inserts from FIGS. 2A and 2B;

FIG. 4 is a flowchart of the method of use of FIGS. 2A and 2B;

FIG. 5 is an exploded view of a dish heating system in accordance with an alternative embodiment of the present application; and

FIG. 6 is a front view of the dish heating system of FIG. 5.

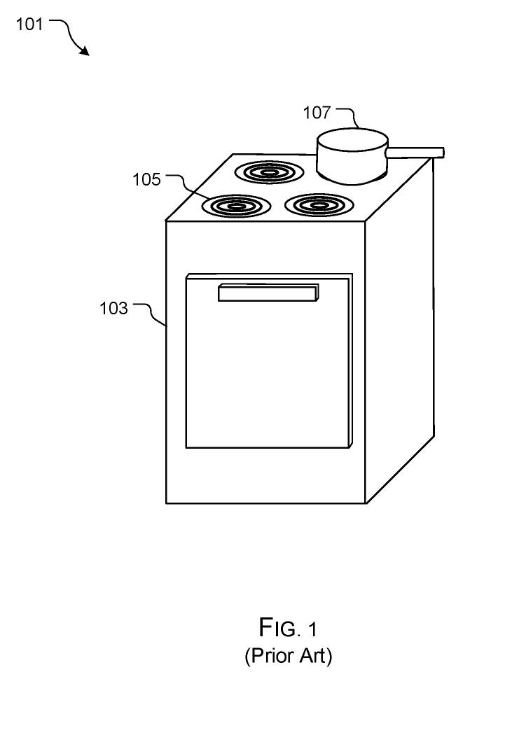

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional heating systems. Specifically, the present invention provides a means to warm and cook food without a stove or microwave. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

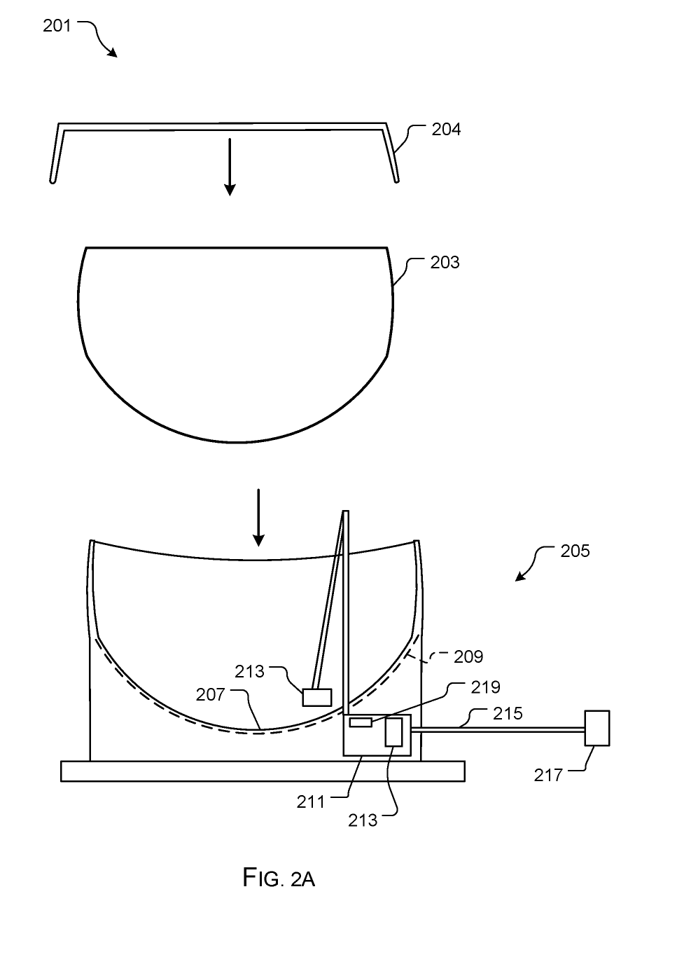

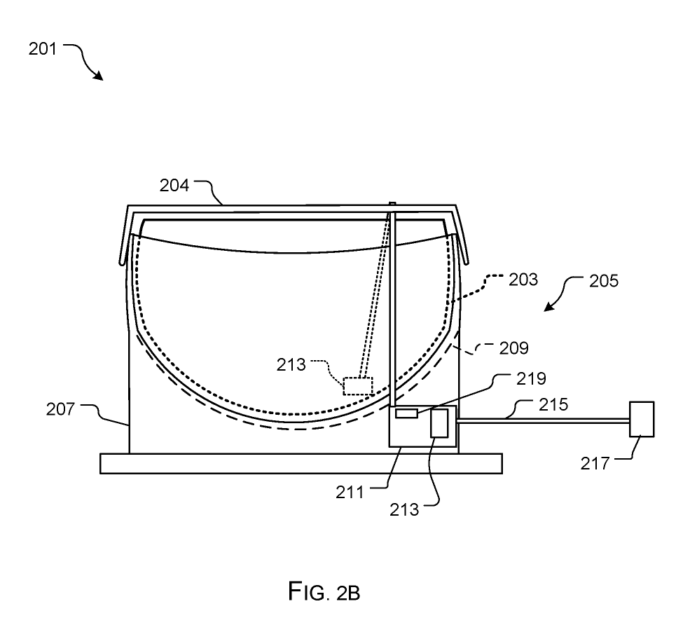

Referring now to the drawings wherein like reference characters identify corresponding or similar elements throughout the several views, FIGS. 2A and 2B depict simplified front views of a dish heating system 201 in accordance with a preferred embodiment of the present application. It will be appreciated that system 201 overcomes one or more of the above-listed problems commonly associated with conventional heating systems.

In the contemplated embodiment, system 201 includes a dish 203 and a heating system 205, wherein the heating system 205 is configured to removably receive the dish and provide heat to warm food or beverage contained within dish 203. It should be appreciated that although dish 203 is shown as a bowl, it is contemplated that system 201 could be adapted for a plate, a cup, and other variously sized dishes.

Heating system 205 includes a base 207 configured to receive dish 203 and a lid 204 configured to secure over dish 203 and to base 207. Base 207 includes a heating element 209 in communication with a control system 211, wherein control system 211 is configured to provide commands to activate heating of element 209. In the preferred embodiment, heating system 205 further includes one or more inserts 213 configured to be placed within dish 203 to heat the contents of dish 203. It should be understood that insert 213 can be metal and includes appropriate wiring to connect to control system 211.

In the preferred embodiment, control system 211 further includes an internal power source 213 such as a rechargeable battery, the power source 213 configured to provide the energy to heat the various components of system 205. It is contemplated that power source 213 can be charged via an external cable 215 connected to an electrical source 217. In one embodiment, electrical source 217 is a USB plug, such as is common on computers.

Control system 211 further includes an activation switch 219 and can be programed with the ability to automatically shut off upon reaching a desired temperature.

It should be appreciated that one of the unique features believed characteristic of the present application is the ability of heating system 205 to be recharged from an electrical source, thereby allowing for the user to heat food without the use of an outlet or a conventional oven.

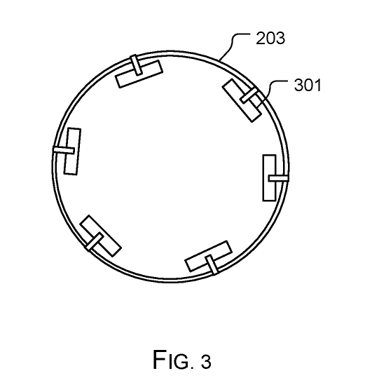

As shown in FIG. 3, in a top view of dish 203, a plurality of heating inserts 301 can be used in connection with system 201. It should be understood that the number, size, and material of inserts 301 can vary as aesthetical, functional, or manufacturing considerations require.

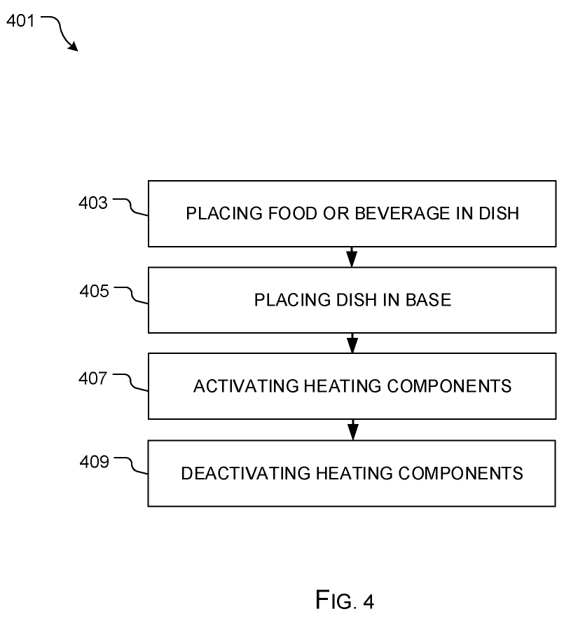

In FIG. 4, a flowchart depicts a method of use associated with system 201. The user places food or a beverage in the dish and secures the dish within the base of the heating system, as shown with boxes 403, 405. The user then proceeds to activate the heating components of the heating system, wherein the food or beverage is heated up, as shown with box 407. The heating system will either shut off automatically upon the reaching of a desired temperature, or the user will deactivate heating, as shown with box 409.

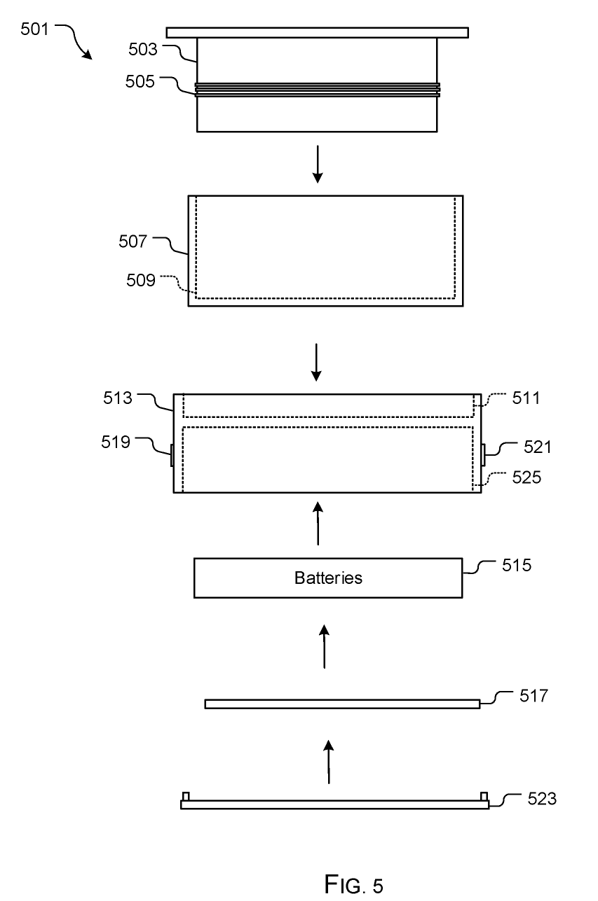

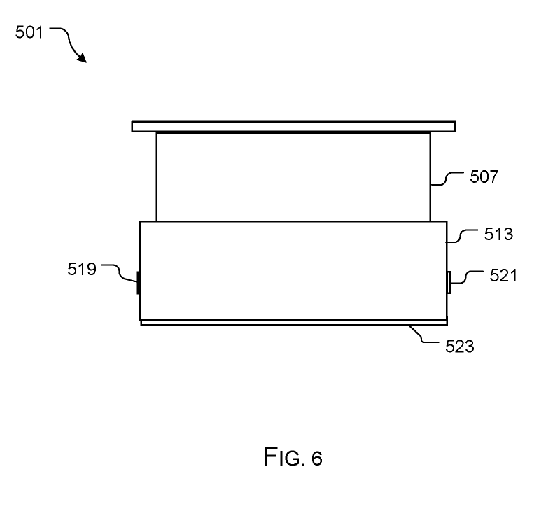

In FIG. 5, an exploded front view depicts an alternative embodiment of a dish heating system 501 in accordance with the present application. System 501 includes a dish 503 such as a ceramic bowl, with one or more resistance heaters 505 surrounding the dish. An insulator 507 can have a cavity 509 to receive dish 503 therein, the insulator 507 being configured to rest within a second cavity 511 of a base plate 513. The insulator can be composed of silicone, or other appropriate material. In this embodiment, the base plate 513 can be configured to hold a power source 515, and a PCB computer board 517 configured to provide heat to insulator and dish 503.

System 501 can include electrical contacts to promote the transfer of heat to the dish. In the preferred embodiment, one or more switches 519 and a charging port 521, to control the heating. A base cover 523 can secure the electrical and power sources inside the cavity 525 of the base plate. In addition, one or more LED lights can be configured to provide notices as to charging heating and the like.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A heated dish system, comprising:
a dish; and
a heating apparatus configured to removably hold the dish, the heating apparatus having:
a base configured to receive the dish;
a control system having an internal power source configured to charge via an external cable configured to plug into an electrical port; and
one or more inserts configured to heat via receiving power from the internal power source;
wherein the one or more inserts are configured to be inserted into the dish to heat food within the dish.

2. The system of claim 1, wherein the dish is a bowl.

3. The system of claim 1, further comprising:
a lid configured to secure over the dish.

4. The system of claim 1, wherein the external cable is configured to plug into a USB port.

5. The system of claim 1, wherein the control system further comprises:
an activation switch configured to activate heating through the one or more inserts.

6. The system of claim 1, wherein the control system is programed with an automatic shut off function configured to shut off the one or more inserts when a predetermined temperature is reached.

7. The system of claim 1, wherein the heating apparatus further comprises:
an exterior heating cradle in communication with the control system and configured to heat the dish from an exterior of the dish.

8. The system of claim 1, wherein the one or more inserts are metal.

9. A heated dish system, comprising:
a dish having one or more resistance heaters surrounding the dish;
an insulator having a cavity configured to receive the dish therein;
a base plate configured to receive the insulator, the base plate having:
a power source; and
a PCB board;
wherein the base plate provides heat to the dish through the insulator.

10. The system of claim 9, wherein the insulator is composed of silicone.

11. The system of claim 9, wherein the base plate further comprises:
one or more switches.

12. The system of claim 9, wherein the dish is composed of ceramic.

13. The system of claim 9, wherein the PCB board is programed with an automatic shut off function configured to shut off the one or more inserts when a predetermined temperature is reached.
